(19) United States
(12) Patent Application Publication
(10) Pub. No.: US 2020/0275172 A1
(43) Pub. Date: Aug. 27, 2020

(54) STEP BY STEP INTERACTIVE VIDEO

(71) Applicants: Justin Lewis Scarsella, Birmingham, AL (US); Abel Martinez, III, Birmingham, AL (US)

(72) Inventors: Justin Lewis Scarsella, Birmingham, AL (US); Abel Martinez, III, Birmingham, AL (US)

(21) Appl. No.: 16/282,935

(22) Filed: Feb. 22, 2019

(51) Int. Cl. H04N 21/8545; H04N 21/845; H04N 21/422; G06F 3/0488

(52) U.S. Cl. CPC H04N 21/8545; G06F 3/04883; H04N 21/42224; H04N 21/8456

(57) ABSTRACT

A system and method for displaying a step by step interactive video includes a computing system having a processor, a memory, and a user interface. The user interface at least a display and a selector. The processor produces a video on the display of a routine having a plurality of moves. The video is segmented into a plurality of segments each having a plurality of frames of a different move of the plurality of moves. The processor further plays the plurality of frames of one of the plurality of segments and then pauses on one of the plurality of frames displaying a completed move each time the selector is activated.

### BACKGROUND OF THE INVENTION

The present invention relates to practicing routines and, more particularly, to a step by step interactive video for practicing and memorizing routines.

Practicing or memorizing a physical routine such as a gymnastic, dance, martial arts, exercise, or football routes from a video is difficult to do. To do so, one must stop and start and restart a video, which is frustrating and can lead to practicing a routine the wrong way or not practicing at all.

As can be seen, there is a need for a step by step interactive video for practicing and memorizing routines.

### SUMMARY OF THE INVENTION

In one aspect of the present invention, a system for displaying a step by step interactive video comprises: a computing system comprising a processor, a memory, and a user interface, the user interface comprising at least a display and a selector, wherein the processor produces a video on the display of a routine having a plurality of moves, wherein the video is segmented into a plurality of segments each comprising a plurality of frames of a different move of the plurality of moves; and plays the plurality of frames of one of the plurality of segments and then pauses on one of the plurality of frames displaying a completed move each time the selector is activated.

In another aspect of the present invention, a method of displaying a step by step interactive video comprises: producing, via a display of a computing system, a video of a routine having a plurality of moves, wherein the video is segmented into a plurality of segments each comprising a plurality of frames of a different move of the plurality of moves; and playing, via the display of the computing system, the plurality of frames of one of the plurality of segments and then pauses on one of the plurality of frames displaying a completed move each time the selector is activated.

These and other features, aspects and advantages of the present invention will become better understood with reference to the following drawings, description and claims.

### BRIEF DESCRIPTION OF THE DRAWINGS

FIG. 1 is a diagram illustrating a screen shot of an embodiment of the present invention;

FIG. 2 is a diagram illustrating a screen shot of an embodiment of the present invention;

FIG. 3 is a diagram illustrating a screen shot of an embodiment of the present invention; and

FIG. 4 is a diagram illustrating a screen shot of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method of displaying a video broken into segments to be controlled with a selection in order to help someone learn from the videos. The present invention allows individuals to practice a routine (i.e. martial arts, gymnastics, dance, cheerleading, etc.) step-by-step with the video stopping at a specific point after a selection. The method of interacting with the video is simple and quick with starting and stopping points preset for the individual to be able to focus on learning and memorizing the routine instead of controlling the video.

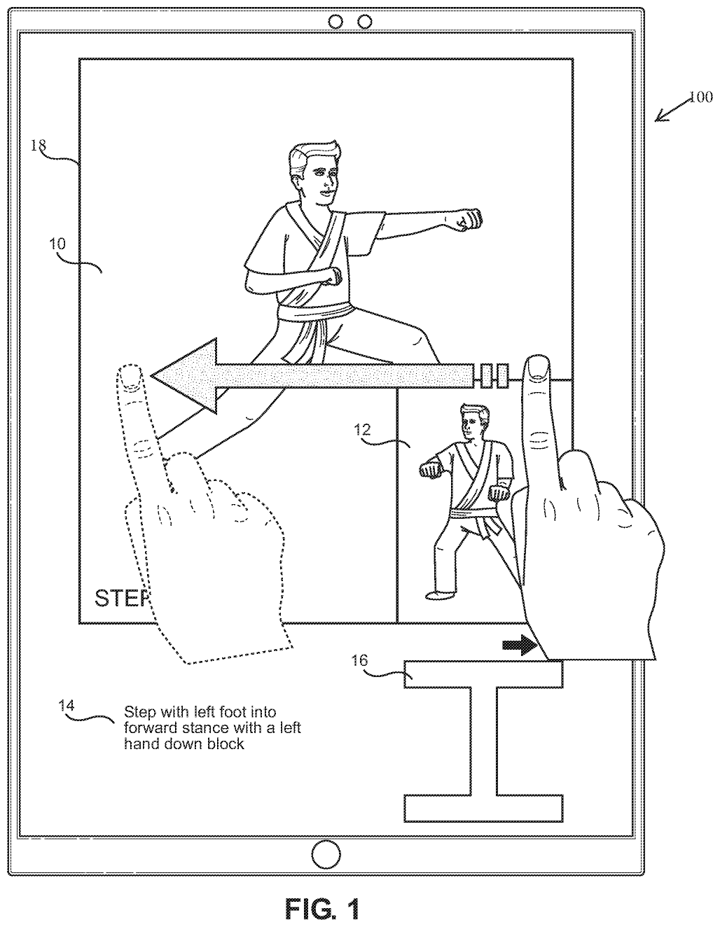

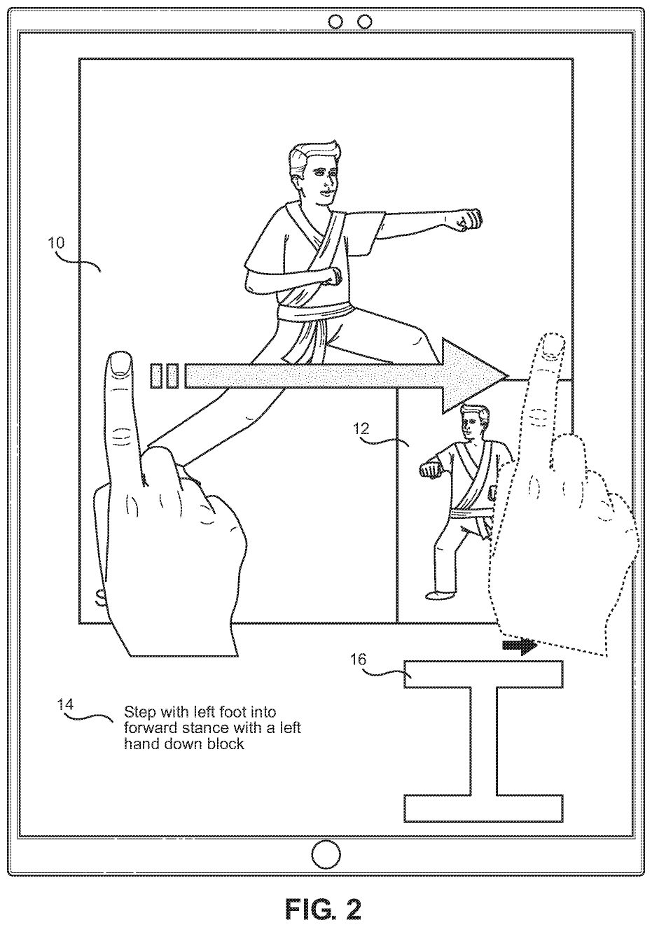

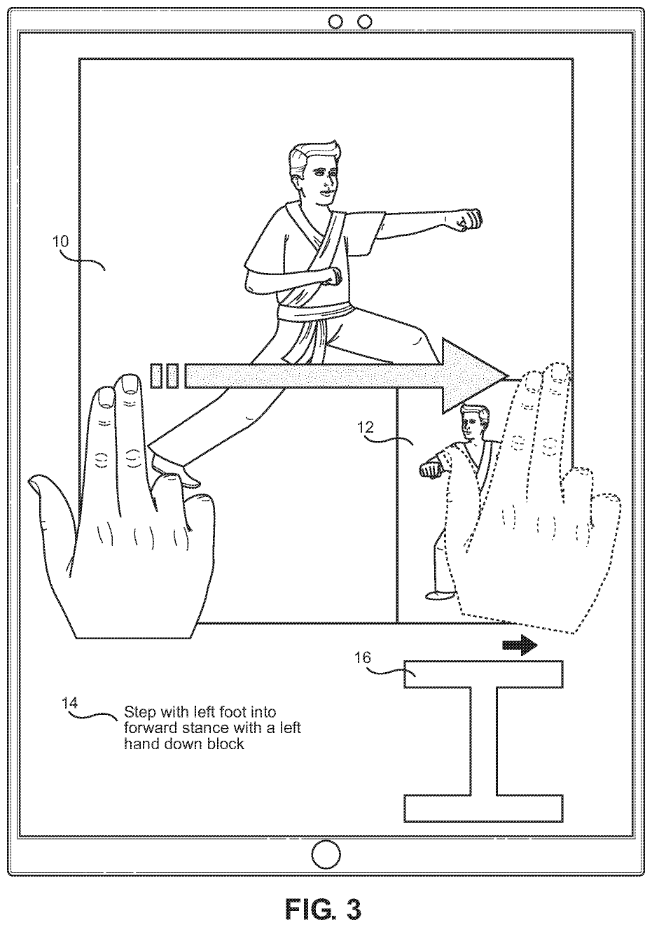

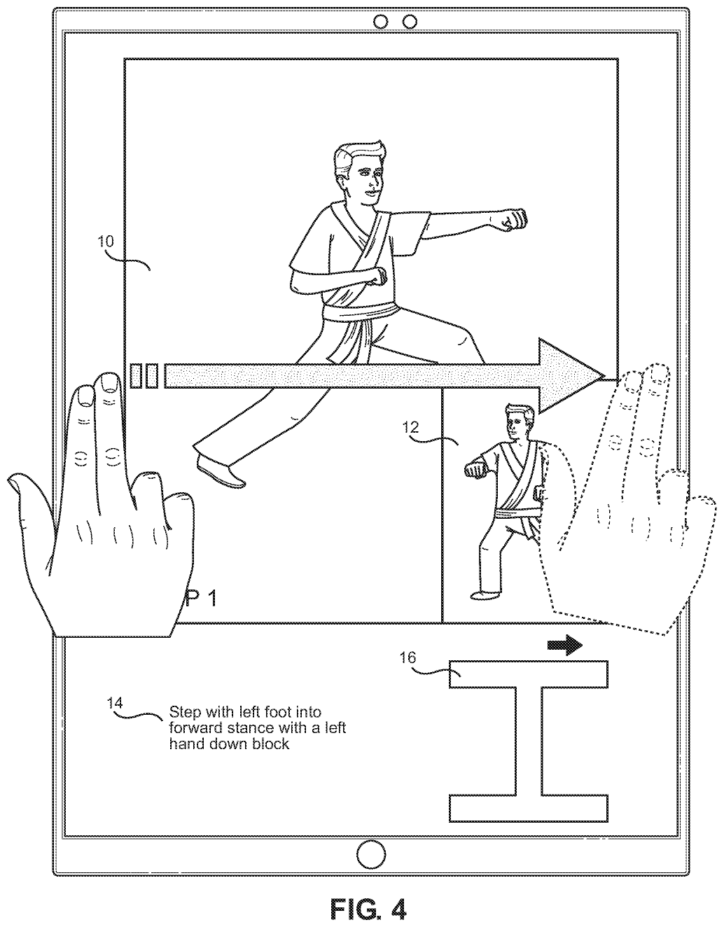

Referring to FIGS. 1 through 4, the present invention includes a system and method for displaying a step by step interactive video. The system and method includes a computing system 100 having a processor, a memory, and a user interface 18. The user interface 18 is at least a display and a selector. The processor produces a video 10 on the display of a routine having a plurality of moves. The video 10 is segmented into a plurality of segments each having a plurality of frames of a different move of the plurality of moves. The processor further plays the plurality of frames of one of the plurality of segments and then pauses on one of the plurality of frames displaying a completed move each time the selector is activated.

The computing system 100 may include a smart device, such as a tablet or a smart phone. The computing system 100 is not limited to a smart device and may include desktop, laptop and the like. As mentioned above, the computing system 100 includes a processor, a memory, and a user interface that includes at least a display and a selector. The user interface includes hardware, software, or both providing one or more interfaces for communication between the user and the computing system 100. As an example and not by way of limitation, a user interface may include a keyboard, keypad, microphone, monitor, mouse, printer, scanner, speaker, still camera, stylus, touchscreen, trackball, video camera, virtual reality optics and interfaces, augmented reality optics and interfaces, another suitable device or a combination of two or more of these.

In certain embodiments, the computing system 100 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems.

The memory is for storing instructions such as computer program(s) for the processor to execute, or data for processor to operate on. The memory may further include storage of data, such as the videos. As an example and not by way of limitation, the memory may include an HDD, a floppy disk drive, flash memory, an optical disc, a magneto-optical disc, magnetic tape, a Universal Serial Bus (USB) drive, a solid-state drive (SSD), or a combination of two or more of these. The memory may include removable or non-removable (or fixed) media, where appropriate. The memory may be internal or external to computing system 100, where appropriate. In particular embodiments, the memory is non-volatile, solid-state memory.

As mentioned above, the user interface, i.e. the display and the selector, may be a touchscreen. As illustrated in the Figures, activating the selector may include swiping the touchscreen in a first direction to display a next segment of the plurality of segments in a sequential order. In such embodiments, activating the selector further includes swiping the touchscreen in a second direction opposite the first direction to replay the segment or play a previous segment of the plurality of segments in the sequential order. The present invention may be performed using something other than a touchscreen, such as a mouse, a keyboard, voice activation, movement activation, and the like.

In certain embodiments, the video 10 includes a main video and a secondary video 12 overlaid on the main video. The main video is of the routine having the plurality of moves, and the secondary video 12 is of the routine having the plurality of moves shot at a different angle relative to the main video. When displaying the video 10, both the main video and the secondary video 12 are viewable at the same time. Each of the main video and the secondary video 12 display the same segments, each with the same respective moves. Therefore, a viewer is able to view each move at multiple angles.

The video 10 of the present invention may include additional overlaid portions, such as an additional video overlay and sound overlays. For example, the video 10 may include a plurality of overlaid texts 14 for each segment. The text 14 is displayed within each of the plurality of segments describing the respective move of the respective segment. The video 10 may further include a bird's eye view 16 of the movement of each move for each segment. The bird's eye view 16 of the movement is displayed within each of the plurality of segments illustrating the movement of each of the respective moves.

The following is an exemplary method of using the present invention. Open up an application on a smart device or video with the segments as described above. Click the video of the routine you want to play and learn from. Swipe with one finger on the video from right to left to play the first preset segment having the first move. If you want to see the movement again swipe left to right. To continue to the second or next movement swipe again right to left. An additional feature may include viewing the previous movement by swiping left to right with two fingers. To restart from the beginning swipe from the left edge of the screen.

It should be understood, of course, that the foregoing relates to exemplary embodiments of the invention and that modifications may be made without departing from the spirit and scope of the invention as set forth in the following claims.

What is claimed is:

1. A system for displaying a step by step interactive video comprising:
a computing system comprising a processor, a memory, and a user interface, the user interface comprising at least a display and a selector, wherein the processor
produces a video on the display of a routine having a plurality of moves, wherein the video is segmented into a plurality of segments each comprising a plurality of frames of a different move of the plurality of moves; and
plays the plurality of frames of one of the plurality of segments and then pauses on one of the plurality of frames displaying a completed move each time the selector is activated.

2. The system of claim 1, wherein the video comprises a main video and a secondary video overlaid on the main video, wherein the main video is of the routine having the plurality of moves, and the secondary video is of the routine having the plurality of moves shot at a different angle relative to the main video.

3. The system of claim 1, wherein a text is displayed within each of the plurality of segments describing the respective move of the respective segment.

4. The system of claim 1, wherein the display and the selector is a touchscreen.

5. The system of claim 4, wherein activating the selector comprises swiping the touchscreen in a first direction to display a next segment of the plurality of segments in a sequential order.

6. The system of claim 5, wherein activating the selector further comprises swiping the touchscreen in a second direction opposite the first direction to replay the segment or play a previous segment of the plurality of segments in the sequential order.

7. A method of displaying a step by step interactive video comprising:
producing, via a display of a computing system, a video of a routine having a plurality of moves, wherein the video is segmented into a plurality of segments each comprising a plurality of frames of a different move of the plurality of moves; and
playing, via the display of the computing system, the plurality of frames of one of the plurality of segments and then pauses on one of the plurality of frames displaying a completed move each time the selector is activated.

8. The method of claim 7, wherein the video comprises a main video and a secondary video overlaid on the main video, wherein the main video is of the routine having the plurality of moves, and the secondary video is of the routine having the plurality of moves shot at a different angle relative to the main video.

9. The method of claim 7, wherein a text is displayed within each of the plurality of segments describing the respective move of the respective segment.

10. The method of claim 7, wherein the display and the selector is a touchscreen.

11. The method of claim 10, wherein activating the selector comprises swiping the touchscreen in a first direction to display a next segment of the plurality of segments in a sequential order.

12. The method of claim 11, wherein activating the selector further comprises swiping the touchscreen in a second direction opposite the first direction to replay the segment or play a previous segment of the plurality of segments in the sequential order.
